(19) United States
(12) Patent Application Publication
(10) Pub. No.: US 2007/0273286 A1
(43) Pub. Date: Nov. 29, 2007

(54) Low-Pressure Mercury Vapor Discharge Lamp And Display Device

(75) Inventor: Rolf Erwin De Man, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,710

(22) PCT Filed: May 4, 2005
(86) PCT No.: PCT/IB05/51458

§ 371 Date: Nov. 6, 2006

(30) Foreign Application Priority Data
May 11, 2004 (EP) 04102020.7

(51) Int. Cl. H01J 61/20

(52) U.S. Cl. 313/639

(57) ABSTRACT

A low-pressure mercury vapor discharge lamp operates in either a first or a second mode of operation. The discharge lamp has a discharge vessel (1), enclosing a discharge space (8). A first end portion (11) of the discharge vessel is provided with a first electrode (12) and a first anode (13) in the vicinity of each other. A second end portion 21 of the discharge vessel is provided with a second electrode 22 and a second anode 23 in the vicinity of each other. While the discharge lamp operates in the first mode of operation, a discharge is maintained alternating between the first electrode and the second anode and between the second electrode and the first anode. While the discharge lamp operates in the second mode of operation, a discharge is maintained alternating between the first electrode and the first anode and between the second electrode and the second anode.

The invention relates to a low-pressure mercury vapor discharge lamp being operable in either a first or a second mode of operation.

The invention also relates to a display device comprising at least one low-pressure mercury vapor discharge lamp for illuminating the display device.

In mercury vapor discharge lamps, mercury constitutes the primary component for the (efficient) generation of ultraviolet (UV) light. A luminescent layer comprising a luminescent material may be present on an inner wall of the discharge vessel to convert UV to other wavelengths, for example, to UV-B and UV-A for tanning purposes (sun panel lamps) or to visible radiation for general illumination purposes or for illumination display devices. Such discharge lamps are therefore also referred to as fluorescent lamps. The discharge vessel of low-pressure mercury vapor discharge lamps is usually circular and comprises both elongate and compact embodiments. Generally, the tubular discharge vessel of compact fluorescent lamps comprises a collection of relatively short straight parts having a relatively small diameter, the straight parts being connected together by means of so-called bridge parts or via so-called bent parts. Generally, means for maintaining a discharge in the discharge space are electrodes arranged in the discharge space.

Low-pressure mercury vapor discharge lamps are frequently used as backlight in display devices comprising a plurality of display lines. An example of such a display device is a liquid crystal display (LCD) device. Such display devices are used in a variety of applications such as in laptops and in television sets.

Patent Application US-A 2002/0130830 discloses a liquid crystal display (LCD) device employing (cold-cathode) fluorescent lamps as a light source and having an adaptive luminance intensifying function and driving method thereof. A timing controller checks features of externally provided image data, and when they are found to be moving pictures, it determines a luminance level required from the image data and outputs a luminance level control signal, and when they are found to be still images, outputs a predetermined luminance signal. A backlight driver outputs a high-potential backlight driving voltage to the backlight unit when a luminance control signal of high-luminance level driving is provided by the timing controller, and outputs a constant level luminance signal when a constant luminance signal is input. As a result, by selecting a plurality of portions of the displayed screen and tracking and monitoring the changes of the image data, features of the images are defined and application conditions of the luminance intensifying function are determined to control the luminance level of the backlight and outputs of gamma voltage levels. Accordingly, the contrast of a display screen is improved and the power consumption is lowered.

A drawback of the known display device is that low-pressure mercury vapor discharge lamp has limited lifetime.

The invention has for its object to eliminate the above disadvantage wholly or partly. According to the invention, a compact low-pressure mercury vapor discharge lamp being operable in either a first or a second mode of operation, the discharge lamp comprising:

a light-transmitting discharge vessel, enclosing, in a gastight manner, a discharge space provided with an inert gas mixture and with mercury,

a first end portion of the discharge vessel being provided with a first electrode arranged in the discharge space,

a first anode being arranged in the discharge space in the vicinity of the first electrode,

a second end portion of the discharge vessel being provided with a second anode arranged in the discharge space,

a discharge being maintained between the first electrode and the second anode while the discharge lamp operates in the first mode of operation, and

a discharge being maintained between the first electrode and the first anode while the discharge lamp operates in the second mode of operation.

In operation, the low-pressure mercury vapor discharge lamp according to the invention is either in the first mode of operation or in the second mode of operation. In the first mode of operation a discharge in the discharge vessel is maintained between the first electrode and the second anode. In the first mode of operation the discharge in the discharge vessel extends between the first and the second portion of the discharge vessel which practically corresponds to a discharge over the entire length of the discharge vessel. In the second mode of operation a discharge is maintained between the first electrode and the first anode. As both the first electrode and the first anode are arranged in the first end portion of the discharge vessel, the discharge in the discharge vessel, when the discharge lamp operates in the second mode of operation, is located in the first end portion of the discharge vessel. In the second mode of operation there is no discharge over practically the entire length of the discharge vessel. In the low-pressure mercury vapor discharge lamp according to the invention there is no change in the setting of the electrode in the discharge lamp being either in the first or in the second mode of operation.

In the known low-pressure mercury vapor discharge lamp, the discharge in the discharge vessel is switched on while the discharge lamp operates in the first mode of operation and the discharge is switched off while the discharge lamp operates in the second mode of operation. If a discharge lamp is totally switched off during a certain period of time (typically larger than approximately 2-4 ms) the discharge must be re-ignited when the discharge lamp is switched on again. Switching on and off a low-pressure mercury vapor discharge lamp is detrimental for an electrode because of increased emitter depletion. Emitter depletion results in a shorter life of the known low-pressure mercury vapor discharge lamp. A way to overcome this problem is not to switch off the discharge in the discharge lamp entirely in the second mode of operation, but to maintain a relatively low so-called “keep-alive” current during the second mode of operation, while keeping the electrode heated. However, this reduces the contrast ratio between the discharge lamp operating in the first mode of operation as compared to the discharge lamp operating in the second mode of operation (lower contrast between “on” and “off”). In addition, the electrode must be able to operate optimally with respect to lifetime at two relatively extreme current settings, i.e. at a relatively very high current while the discharge lamp operates in the first mode of operation and at relatively very low current (“keep-alive” current) while the discharge lamp operates in the second mode of operation.

In the low-pressure mercury vapor discharge lamp according to the invention the electrode operates practically under the same conditions independent of whether the discharge lamp operates in the first mode of operation or whether the discharge lamp operates in the second mode of operation.

A preferred embodiment of the low-pressure mercury vapor discharge lamp according to the invention is characterized in that the first anode is connected to the first electrode via a first diode. The electrode in the low-pressure mercury vapor discharge lamp according to this preferred embodiment functions as cathode and can be optimally designed for this function.

Normally, the discharge vessel is provided with two electrodes, each of the electrodes being arranged in its respective end portions of the discharge vessel. To this end another embodiment of the low-pressure mercury vapor discharge lamp according the invention is characterized in that the second end portion is provided with a second electrode arranged in the discharge space, the second electrode being arranged in the vicinity of the second anode, a discharge being maintained alternating between the first electrode and the second anode and between the second electrode and the first anode, while the discharge lamp operates in the first mode of operation, and a discharge being maintained alternating between the first electrode and the first anode and between the second electrode and the second anode while the discharge lamp operates in the second mode of operation.

A preferred embodiment of the low-pressure mercury vapor discharge lamp according to the invention is characterized in that the first anode is connected to the first electrode via a first diode, and the second anode is connected to the second electrode via a second diode.

When the discharge lamp operates in the first mode of operation, the current in the discharge lamp flows during one phase of the current via the first diode and the first anode to the second electrode. During the other phase of the current, the current in the discharge lamp flows via the second diode and the second anode to the first electrode. In this case there is an AC discharge in the discharge vessel between the first and the second anode. In addition, there is a quasi DC discharge in the discharge vessel between the second anode and the second electrode during one phase of the current in the second end portion of the discharge vessel and there is a quasi DC discharge in the discharge vessel between the first anode and the first electrode during the other phase of the current in the first end portion of the discharge vessel. When the discharge lamp operates in the first mode of operation, the entire discharge lamp emits light.

When the discharge lamp operates in the second mode of operation, the current in the discharge lamp flows during one phase of the current via the first diode and the second anode to the second electrode. During the other phase of the current, the current in the discharge lamp flows via the second diode and the first diode to the first electrode. In this case there is no discharge in the discharge vessel between the first and the second anode. However, there is still a quasi DC discharge in the discharge vessel between the second anode and the second electrode during one phase of the current in the second end portion of the discharge vessel and there is still a quasi DC discharge in the discharge vessel between the first anode and the first electrode during the other phase of the current in the first end portion of the discharge vessel. When the discharge lamp operates in the second mode of operation, the discharge lamp does not emit light between the first and the second electrode. When the discharge lamp operates in the second mode of operation, the majority of the discharge lamp does not emit light.

There is no change in the electrode setting between a discharge lamp operating in the first or in the second mode of operation. In the discharge lamp according to the invention the electrodes operate in a fixed regime independent whether the discharge lamp operates in the first or in the second mode of operation. Another advantage of the provision of the first and second diode is that the first and the second electrode function as cathode and can be optimally designed for this function.

A preferred embodiment of the low-pressure mercury vapor discharge lamp according to the invention is characterized in that the discharge vessel in the vicinity of the first and a second end portions are kept free from luminescent material.

A favorable embodiment of the low-pressure mercury vapor discharge lamp according to the invention is characterized in that the discharge vessel comprises a tubular main portion and a first and a second tubular side portion, the first and the second tubular side portions being arranged adjacent the respective ends of the tubular main portion, the first and the second tubular side portions being connected to the tubular main portion via first and second tubular interconnection means, respectively, the first and the second end portion of the discharge vessel being arranged in the first and the second tubular side portions. This embodiment is particularly favorable if low-pressure mercury vapor discharge lamps are employed to illuminate a display device and a uniform illumination of the image on the display device is desired. In general, a plurality of low-pressure mercury vapor discharge lamps according to the preferred embodiment of the invention is used in a so-called backlight illumination system. The first and the second tubular side portions can be positioned in the backlight illumination system at a side of the display device facing away from the image displayed on the display device.

A preferred embodiment of the low-pressure mercury vapor discharge lamp according to the invention is characterized in that the first and a second tubular side portion are kept free from luminescent material. The first and a second tubular side portion practically do not emit light when the low-pressure mercury vapor discharge lamp is in the second mode of operation.

Preferably, the first and second tubular interconnection means comprises a bridge portion or a bent portion.

The invention also relates to a display device comprising at least one low-pressure mercury vapor discharge lamp for illuminating the display device. According to the invention, a display device comprising a plurality of display lines, the display device including a control unit and comprising at least one low-pressure mercury vapor discharge lamp as described hereinabove for illuminating an associated group of the display lines, the control unit being operative to switch the low-pressure mercury vapor discharge lamp between the first and the second mode of operation at a switching frequency that corresponds to a scanning frequency of the display device, the low-pressure mercury vapor discharge lamp being in the second mode of operation during the scanning of the associated group of display lines. The advantage of switching the low-pressure mercury vapor discharge lamp between the first and the second mode of operation at a switching frequency corresponding to the scanning frequency of the display device is that motion artifacts of the display device is substantially reduced, in particular for a liquid crystal display device. The low-pressure mercury vapor discharge lamp is in the second mode of operation when the display device scans the associated group of display lines. Such switching of the low-pressure mercury vapor discharge lamp is also known as “scanning backlight”.

A preferred embodiment of the display device according to the invention is characterized in that the control unit is operative to switch the low-pressure mercury vapor discharge lamp to the second mode of operation a pre-determined first period t_{b} before scanning the display line and to switch to the first mode of operation a pre-determined second period tₐ after the scanning the display line. Motion artifacts of the display device are substantially reduced.

These and other aspects of the invention are apparent from and will be elucidated with reference to the embodiments described hereinafter.

In the drawings:

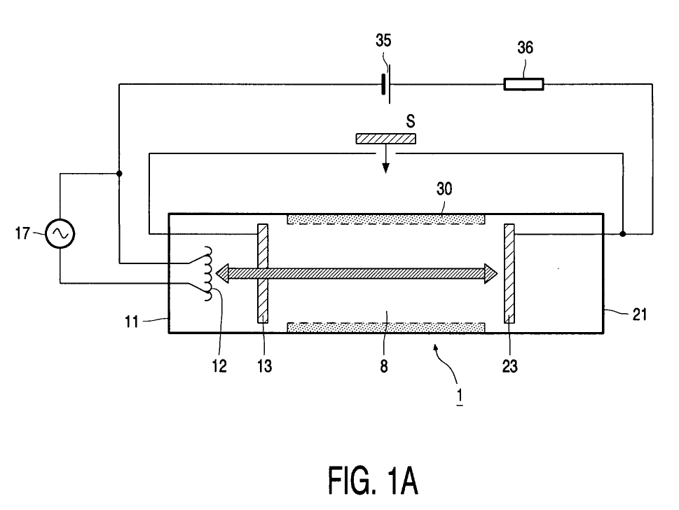

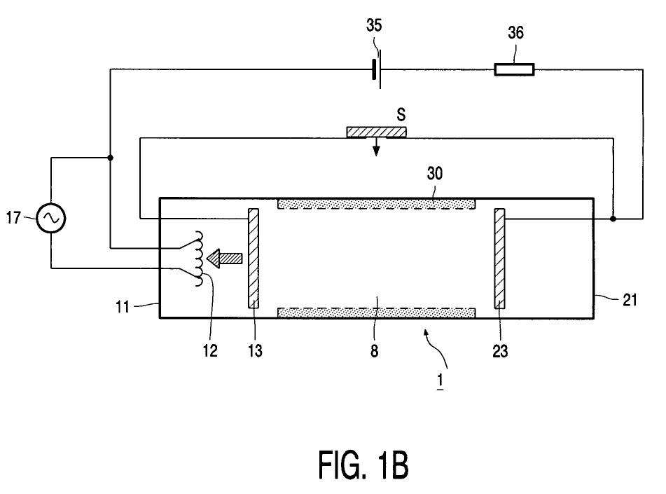

FIG. 1A shows a cross-sectional view of a first embodiment of the low-pressure mercury-vapor discharge lamp in accordance with the invention in the first mode of operation;

FIG. 1B shows a cross-sectional view of a first embodiment of the low-pressure mercury-vapor discharge lamp in accordance with the invention in second mode of operation;

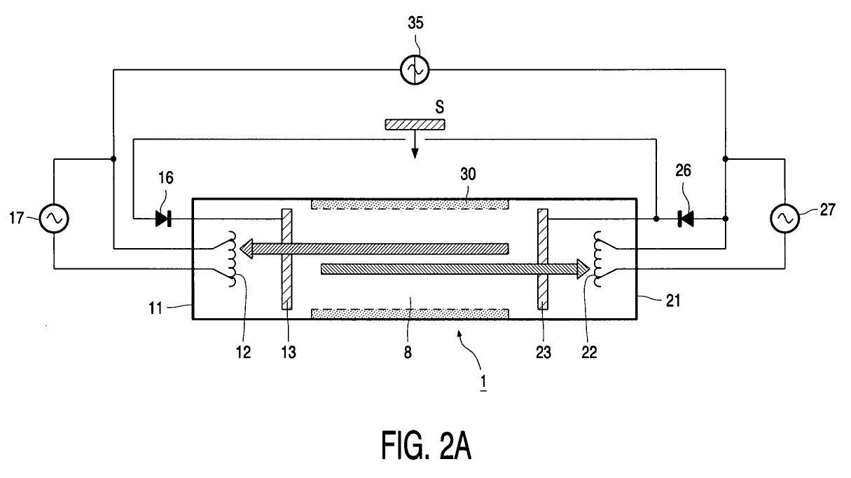

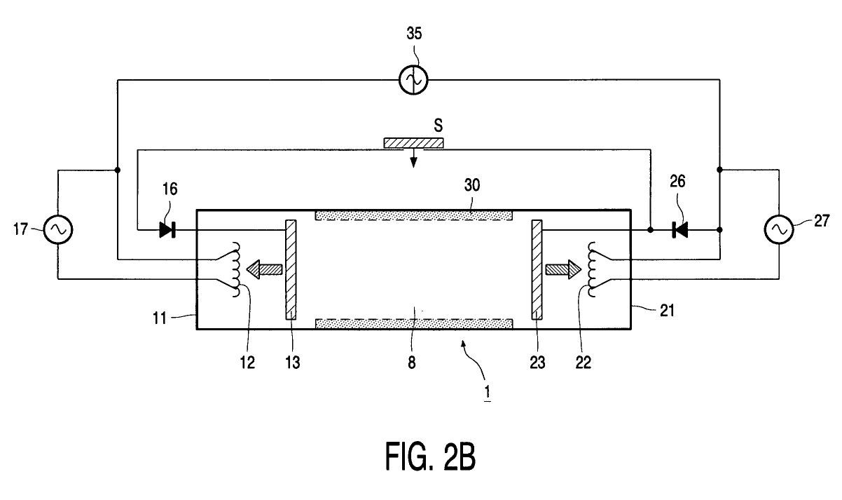

FIG. 2A shows a cross-sectional view of a second embodiment of the low-pressure mercury-vapor discharge lamp in accordance with the invention in the first mode of operation;

FIG. 2B shows a cross-sectional view of a second embodiment of the low-pressure mercury-vapor discharge lamp in accordance with the invention in second mode of operation;

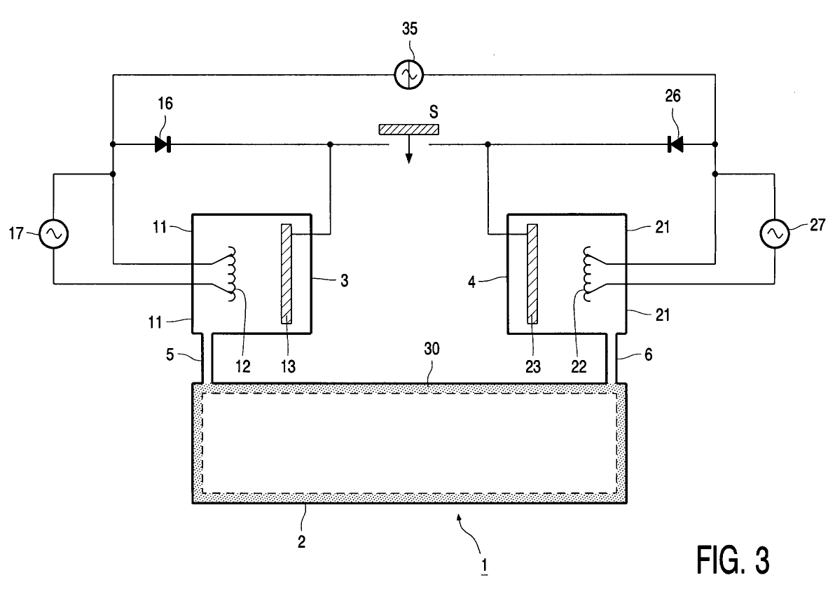

FIG. 3 shows a cross-sectional view of a third embodiment of the low-pressure mercury-vapor discharge lamp in accordance with the invention in the first mode of operation;

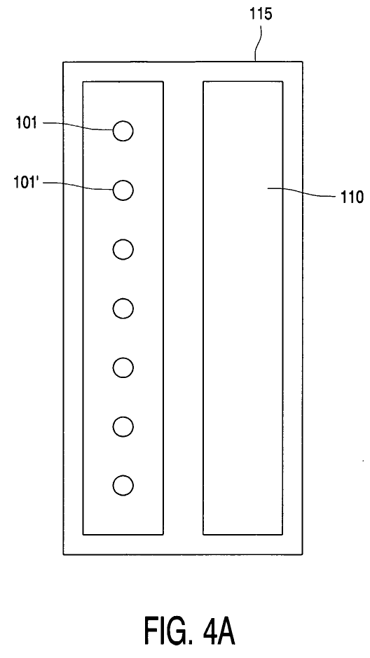

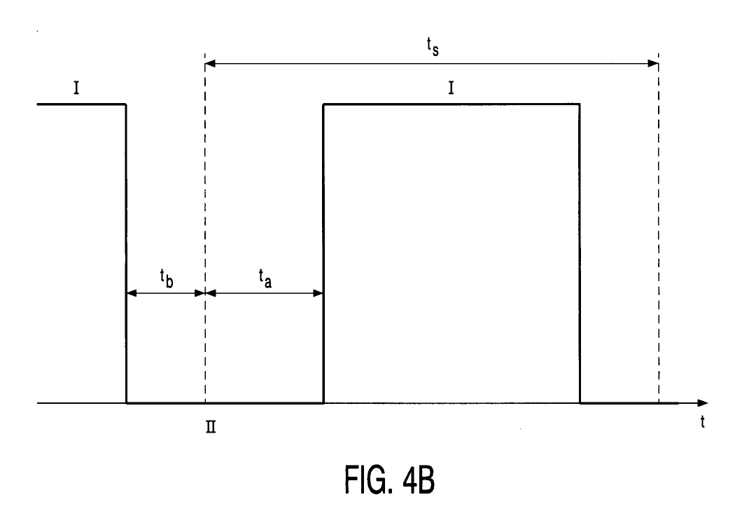

FIG. 4A shows a cross-sectional view of a display device in accordance with the invention provided with a plurality of low-pressure mercury-vapor discharge lamps in accordance with the invention, and

FIG. 4B shows switching between the first mode and the second mode of operation corresponding with the scanning time of the display device.

The Figures are purely diagrammatic and not drawn to scale. Notably, some dimensions are shown in a strongly exaggerated form for the sake of clarity. Similar components in the Figures are denoted as much as possible by the same reference numerals.

FIG. 1A and 1B schematically show a first embodiment of a low-pressure mercury vapor discharge lamp which is operable either in a first mode of operation (FIG. 1A) or in a second mode of operation (FIG. 1B). The discharge lamp comprises a light-transmitting discharge vessel 1, enclosing, in a gastight manner, a discharge space 8 provided with an inert gas mixture and with mercury.

In the example of FIGS. 1A and 1B part of an inner surface of the discharge vessel 1 is coated with a layer 30 with a fluorescent material. In particular, the discharge vessel 1 in the vicinity of the first end portion 11 and the second end portion 21 are kept free from luminescent material. When the low-pressure mercury vapor discharge lamp operates in the second mode of operation there will be little output of visible light by the discharge lamp.

The discharge vessel 1 has a first end portion 11 provided with a (first) electrode 12 arranged in the discharge space 8. Current-supply conductors connected to the electrode 12 issue via the first end portion 11 to the exterior of the discharge vessel 1. In addition, a first anode 13 is arranged in the discharge space 8 in the vicinity of the (first) electrode 12. Preferably, a further current-supply connector from the first anode 13 to the exterior of the discharge vessel is electrically isolated, preferably by providing a glass tube around the further current-supply conductor (not shown in FIG. 1). The anode is made from a metal and can have the shape of a rod, a sheet of metal, a metal ring or also a “normal” electrode with or without emitter material. An opposing end of the discharge vessel 1 has a second end portion 21 which is provided with a second anode 23 arranged in the discharge space 8. In the example of FIG. 1A representing the discharge lamp operating in the first mode of operation, a discharge is maintained between the first electrode 12 and the second anode 23. In the example of FIG. 1B representing the discharge lamp in the second mode of operation, a discharge is maintained between the first electrode 12 and the first anode 13.

In the embodiment of the low-pressure mercury vapor discharge lamp shown in FIGS. 1A and 1B there is only one electrode (reference numeral 12). In addition, FIGS. 1A and 1B show very schematically a manner in which the low-pressure mercury vapor discharge lamp operates. The manner of operating the low-pressure mercury vapor discharge lamp as shown in FIGS. 1A and 1B results in a DC discharge. Power supply 17 provides the first electrode 12 with electrical power. A ballast 35 is provided connecting the first electrode 12 to the second anode 23. Preferably, a resistance 36 is arranged in the circuitry of the discharge lamp. The first anode 13 is connected to the second anode 23 via a switch S. Switch S is open when the discharge lamp operates in the first mode of operation (FIG. 1A) and switch S is closed when the discharge lamp operates in the second mode of operation (FIG. 1B).

When the discharge lamp operates in the first mode of operation, the discharge is located between the (first) electrode 12 and the second anode 23. This is indicated by the bold two-sided arrow in FIG. 1A between the first electrode 12 and the second anode 23. When there is only one electrode, the discharge lamp is preferably operated under DC conditions in such a manner that the discharge is always from the second anode 23 to the (first) electrode 12. In this manner the life time of the first electrode is improved.

As both the (first) electrode 12 and the first anode 13 are arranged in the first end portion 11 of the discharge vessel 1, the discharge in the discharge vessel 1, when the discharge lamp operates in the second mode of operation (FIG. 1B), is located in the first end portion 11 of the discharge vessel 1. This is indicated by the bold arrow in FIG. 1B between the first anode 13 and the (first) electrode 12. In the second mode of operation there is no discharge over practically the entire length of the discharge vessel. In the low-pressure mercury vapor discharge lamp according to the invention there is no change in the setting of the (first) electrode 12 whether the discharge lamp operates in the first or in the second mode of operation.

In order to obtain a high light output of the low-pressure mercury vapor discharge lamp according to the invention, heated cathodes are used as electrode in stead of so-called “cold-cathode” electrodes in the known low-pressure mercury vapor discharge lamp.

FIGS. 2A and 2B schematically show a cross-sectional view of a second embodiment of the low-pressure mercury-vapor discharge lamp which is operable either in a first mode of operation (FIG. 2A) or in a second mode of operation (FIG. 2B). The manner of operating the low-pressure mercury vapor discharge lamp as shown in FIGS. 2A and 2B results in a AC discharge. In the situation of FIGS. 2A and 2B there are two electrodes in the discharge vessel. In particular, a second electrode 22 is arranged in the discharge space 8 in the second end portion 21. The second electrode 22 is arranged in the vicinity of the second anode 23. Preferably, the first anode 13 is connected to the first electrode 12 via a first diode 16, and the second anode 23 is connected to the second electrode 22 via a second diode 26.

While the discharge lamp operates in the first mode of operation (FIG. 2A, switch S is open), a discharge is maintained alternating between the second anode 23 and the first electrode 12 (indicated by the bold arrow in FIG. 2A pointing towards the first electrode 12) and between the first anode 13 and the second electrode 22 (indicated by the bold arrow in FIG. 2A pointing towards the second electrode 22). While the discharge lamp operates in the second mode of operation (FIG. 2B, switch S is closed), a discharge is maintained alternating between the first anode 13 and the first electrode 12 (indicated by the bold arrow in FIG. 2B pointing towards the first electrode 12) and between the second anode 23 and the second electrode 22 (indicated by the bold arrow in FIG. 2B pointing towards the second electrode 22).

As both the first electrode 12 and the first anode 13 are arranged in the first end portion 11 and both the second electrode 22 and the second anode 23 are arranged in the second end portion 21 of the discharge vessel 1, the discharge in the discharge vessel 1, when the discharge lamp operates in the second mode of operation (FIG. 2B), is located alternating in the first end portion 11 and in the second end portion 21 of the discharge vessel 1. In the low-pressure mercury vapor discharge lamp according to the invention there is no change in the setting of the first electrode 12 and in the setting of the second electrode 22 whether the discharge lamp operates in the first or in the second mode of operation. In this manner the life time of the electrodes 12; 22 is considerably improved. In the second mode of operation the discharges between the first electrode 12 and the first anode 13 and between the second electrode 22 and the second anode 23 are quasi DC discharges.

In the example of FIGS. 2A and 2B part of an inner surface of the discharge vessel 1 is coated with a layer 30 with a fluorescent material. In particular, the discharge vessel 1 in the vicinity of the first end portion 11 and the second end portion 21 are kept free from luminescent material. When the low-pressure mercury vapor discharge lamp operates in the second mode of operation there will be little output of visible light by the discharge lamp.

FIG. 3 schematically shows a cross-sectional view of a third embodiment of the low-pressure mercury-vapor discharge lamp in accordance with the invention in the first mode of operation (switch S is open). In the example of FIG. 3, the discharge vessel 1 comprises a tubular main portion 2 and a first 3 and a second 4 tubular side portion. The tubular main portion is provided with a layer 30 of a luminescent material. Preferably, the first and second tubular side portion 3; 4 are kept free from luminescent material. In an alternative embodiment, the first and second tubular side portion 3; 4 are covered with a non-transparent coating. Said coating is preferably non-transparent and preferably has protective properties.

The first and second tubular side portions 3; 4 are arranged adjacent the respective ends of the tubular main portion 2. Preferably, the first and second tubular side portions 3; 4 are arranged parallel to the tubular main portion 2. In addition, the first and second tubular side portions 3; 4 are connected to the tubular main portion 2 via a first 5 and a second 6 tubular interconnection means, respectively. In the example of FIG. 3, the first and second tubular interconnection means 5; 6 comprises a bridge portion. In an alternative embodiment, a bent portion is employed to interconnect the first and second tubular side portions to the tubular main portion.

In the example of FIG. 3, the first electrode 12 and the first anode 13 are arranged in the first tubular side portion 3 and the second electrode 22 and the second anode 23 are arranged in the second tubular side portion 4. In the first mode of operation (switch S is open), a discharge is maintained alternating between the second anode 23 and the first electrode 12 and between the first anode 13 and the second electrode 22. In the first mode of operation the discharge lamp emits visible light over the entire length of the tubular main portion 2. While the discharge lamp operates in the second mode of operation (switch S is closed; not shown in FIG. 3), a discharge is maintained alternating between the first anode 13 and the first electrode 12 and between the second anode 23 and the second electrode 22. In the second mode of operation the discharges are present only in the first and second tubular interconnection means 5; 6 and the discharge lamp does not emit light.

In the low-pressure mercury vapor discharge lamp as shown in FIG. 3 there is no change in the setting of the first electrode 12 and in the setting of the second electrode 22 whether the discharge lamp operates in the first or in the second mode of operation. In this manner the life time of the electrodes 12; 22 is considerably improved. In the second mode of operation the discharges between the first electrode 12 and the first anode 13 and between the second electrode 22 and the second anode 23 are quasi DC discharges.

FIG. 4A very schematically shows a cross-sectional view of a display device 110 in accordance with the invention provided with a plurality of low-pressure mercury-vapor discharge lamps 101, 101′, . . . in accordance with the invention. A housing 115 accommodates the plurality of low-pressure mercury-vapor discharge lamps 101, 101′, . . . and the display device 110, by way of example a liquid crystal display (LCD). The display device 110 includes a control unit (not shown in FIG. 4A). In the examples shown in FIGS. 1, 2 and 3, the control unit operates the switch S. In the display unit 110, display lines are written according to a scanning frequency of the display unit 110. The plurality of low-pressure mercury vapor discharge lamps 101, 101′, . . . illuminates an associated group of the display lines. The control unit operates operative to switch the low-pressure mercury vapor discharge lamps 101, 101′, . . . between the first and the second mode of operation at a switching frequency that corresponds to a scanning frequency of the display device 110. The low-pressure mercury vapor discharge lamp 101, 101′, . . . is in the second mode of operation during the scanning of the associated group of display lines.

Preferably, the control unit switches the low-pressure mercury vapor discharge lamp to the second mode of operation a pre-determined first period t_{b} before scanning the display line and switches to the first mode of operation a pre-determined second period tₐ after the scanning the display line. FIG. 4B schematically shows switching between the first mode of operation (indicated by roman “I” in FIG. 4B) and the second mode of operation (indicated by roman “II” in FIG. 4B) corresponding with the scanning time tS of the display device. The scanning time tₛ is the inverse of the scanning frequency of the display device 110. Preferably,
t_{b}+tₐ≦tₛ.
When during scanning of the display lines the associated low-pressure mercury vapor discharge lamp or lamps operate in the second mode of operation, motion artifacts of the display device are considerably reduced.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A low-pressure mercury vapor discharge lamp being operable in either a first or a second mode of operation, the discharge lamp comprising:
a light-transmitting discharge vessel (1), enclosing, in a gastight manner, a discharge space (8) provided with an inert gas mixture and with mercury,
a first end portion (11) of the discharge vessel (1) being provided with a first electrode (12) arranged in the discharge space (8),
a first anode (13) being arranged in the discharge space (8) in the vicinity of the first electrode (12),
a second end portion (21) of the discharge vessel (1) being provided with a second anode (23) arranged in the discharge space (8),
a discharge being maintained between the first electrode (12) and the second anode (23) while the discharge lamp operates in the first mode of operation, and
a discharge being maintained between the first electrode (12) and the first anode (13) while the discharge lamp operates in the second mode of operation.

2. A low-pressure mercury vapor discharge lamp as claimed in claim 1, wherein the first anode (13) is connected to the first electrode (12) via a first diode (16).

3. A low-pressure mercury vapor discharge lamp as claimed in claim 1, wherein
the second end portion (21) is provided with a second electrode (22) arranged in the discharge space (8),
the second electrode (22) being arranged in the vicinity of the second anode (23),
a discharge being maintained alternating between the first electrode (12) and the second anode (23) and between the second electrode (22) and the first anode (13), while the discharge lamp operates in the first mode of operation, and
a discharge being maintained alternating between the first electrode (12) and the first anode (13) and between the second electrode (22) and the second anode (23) while the discharge lamp operates in the second mode of operation.

4. A low-pressure mercury vapor discharge lamp as claimed in claim 3, wherein the first anode (13) is connected to the first electrode (12) via a first diode (16), and the second anode (23) is connected to the second electrode (22) via a second diode (26).

5. A low-pressure mercury vapor discharge lamp as claimed in claim 3, wherein the discharge vessel (1) in the vicinity of the first (11) and a second (21) end portions are kept free from luminescent material.

6. A low-pressure mercury vapor discharge lamp as claimed in claim 1, wherein
the discharge vessel (1) comprises a tubular main portion (2) and a first (3) and a second (4) tubular side portion,
the first (3) and the second (4) tubular side portions being arranged adjacent the respective ends of the tubular main portion (2),
the first (3) and the second (4) tubular side portions being connected to the tubular main portion (2) via first (5) and second (6) tubular interconnection means, respectively,
the first (11) and the second (21) end portion of the discharge vessel (1) being arranged in the first (3) and the second (4) tubular side portions.

7. A low-pressure mercury vapor discharge lamp as claimed in claim 6, wherein the first (3) and a second (4) tubular side portion are kept free from luminescent material.

8. A low-pressure mercury vapor discharge lamp as claimed in claim 6, wherein the first (5) and second (6) tubular interconnection means comprises a bridge portion or a bent portion.

9. A display device comprising a plurality of display lines, the display device including a control unit and comprising at least one low-pressure mercury vapor discharge lamp as claimed in claim 1, for illuminating an associated group of the display lines, the control unit being operative to switch the low-pressure mercury vapor discharge lamp between the first and the second mode of operation at a switching frequency that corresponds to a scanning frequency of the display device, the low-pressure mercury vapor discharge lamp being in the second mode of operation during the scanning of the associated group of display lines.

10. A display device as claimed in claim 9 wherein the control unit is operative to switch the low-pressure mercury vapor discharge lamp to the second mode of operation a pre-determined first period before scanning the display line and to switch to the first mode of operation a pre-determined second period after the scanning the display line.
